(19) United States
(12) Patent Application Publication
(10) Pub. No.: US 2007/0058247 A1
(43) Pub. Date: Mar. 15, 2007

(54) MICROSCOPE WITH FOCUSING DEVICE FOR OBSERVING DEPTH STRUCTURES IN OBJECTS

(75) Inventor: Johannes Winterot, Jena (DE)

Correspondence Address: Gerald H. Kiel, Esq.;REED SMITH LLP, 599 Lexington Avenue, New York, NY, 10022-7650, US

(73) Assignee: Carl Zeiss MicroImaging GmbH

(21) Appl. No.: 11/531,063

(22) Filed: Sep. 12, 2006

(30) Foreign Application Priority Data
Sep. 12, 2005 (DE) 10 2005 043 870.9

(51) Int. Cl. G02B 21/22

(52) U.S. Cl. 359/376

(57) ABSTRACT

The invention is directed to a telescope-type stereo microscope comprising a microscope objective, a tube lens system in each of the two stereoscopic imaging beam paths downstream of the microscope objective, a microscope viewer, and a device for adjusting the focus position by changing the distance z between the microscope objective and an object to be observed. A microscope of the type described above is constructed in such a way that the distances between the object and the microscope viewer and the distance of at least one lens of the tube lens system from the microscope objective or from the microscope viewer are constant when changing the distance z between the microscope objective and the object to be observed, and a real image is always formed at the same location of the microscope viewer. In contrast to the prior art, it is no longer necessary to move the entire mass of the microscope superstructure for focus adjustment. Therefore, the guides and drives required for the focusing movement can be designed so as to save costs and space.

### CROSS-REFERENCE TO RELATED APPLICATION

This application claims priority of German Application No. 10 2005 043 870.9, filed Sept. 12, 2005, the complete disclosure of which is hereby incorporated by reference.

### BACKGROUND OF THE INVENTION

a) Field of the Invention

The invention is directed to a telescope-type stereo microscope comprising a microscope objective, a tube lens system in each of the two stereoscopic imaging beam paths downstream of the microscope objective, a microscope viewer, and means for adjusting the focus position by changing the distance z between the microscope objective and an object to be observed.

b) Description of the Related Art

Stereo microscopes of this type are frequently used to observe depth structures in objects. In order the adjust the focus position on different observation planes, the distance between the microscope objective and the object is generally changed in Z-direction. The object is left in its position while the microscope objective and, along with the latter, the entire microscope superstructure are displaced, including the microscope viewer and, as the case may be, the attached camera, coaxial incident illumination, and the like.

This is disadvantageous in that a considerable mass must be set in motion for focusing so that a costly and compact dimensioning of guides and drives which takes this mass into account is inevitably required resulting in turn in relatively high manufacturing costs.

Further, it is often desirable to view an object through a microscope viewer whose height adjustment is not dependent upon the focusing movement so that the height of the viewer is maintained when the focus position is changed.

Therefore, in the further development of stereo microscopes of this type there is a need to decouple the height adjustment of the viewer and the focusing movement from one another and, at the same time, to minimize the mass to be moved during the focusing movement.

U.S. Pat. No. 6,339,507 describes a stereo microscope in which the distance between the microscope objective and a downstream a focal magnification changer is designed to as to be variable for changing the focus position. The entrance pupil lies in the imaging beam path in the region of the a focal magnification changer. This is disadvantageous in that a variable distance between the microscope objective and the magnification changer inevitably requires a larger construction of the microscope objective.

In connection with Greenough-type stereo microscopes, it is known for changing the distance between the object and the eyepiece intermediate image plane to use optical attachment systems which simultaneously change the imaging scale when the position of the imaged object plane is changed. This is described, for example, in DE 100 38 133 A1. However, the problem described above is not solved in this way.

### OBJECT AND SUMMARY OF THE INVENTION

Proceeding from this prior art, it is the object of the invention to further develop a stereo microscope of the type mentioned in the beginning in such a way that it is possible to change the focus position independently from the height adjustment of the microscope viewer.

According to the invention, a stereo microscope of the type described above is constructed in such a way that the distances between the object and the microscope viewer and the distance of at least one lens of the tube lens system from the microscope objective or from the microscope viewer are constant while changing the distance z between the microscope objective and the object to be viewed, and a real image is always formed at the same location of the microscope viewer.

In a microscope constructed in this way, it is possible to adjust the focus position on different observation planes without needing to also move the entire microscope superstructure along with the movement of the microscope objective.

In contrast to the prior art it is no longer necessary to move the entire mass of the microscope superstructure for focus adjustment. Therefore, the guides and drives required for the focusing movement can be designed so as to save costs and space.

To this extent, the microscope according to the invention has a focusing device which makes it possible to vary the focus position by displacing the microscope objective in Z-direction while the viewer height remains the same.

In each of the two stereoscopic imaging beam paths, a magnification changer is provided between the microscope objective and the tube lens system. The distance between the microscope objective and the magnification changers is constant when changing distance z.

In a particularly advantageous manner, the microscope according to the invention is constructed in such a way that the back focus of the tube lens system is variable, while the focal length F in the selected example is constant at 200 mm. The principle of the invention can be transferred to tube lens systems of variable back focus with focal lengths F in the range of 100≦F≦250.

In a first constructional variant, the microscope is outfitted with a tube lens system comprising three lenses L1, L2, L3, and the distances between the microscope objective, the magnification changer coupled with the latter, and two lenses L1 and L2 are constant.

When changing the distance z, the lenses L1 and L3 are displaced by the same amount by which the microscope objective 1 is displaced in direction R jointly with the magnification changers, that is, the displacement of lenses L1 and L3 is directly coupled with the displacement of the microscope objective 1 and of the magnification changers.

In so doing, the position of the lenses L1 and L3 relative to the lens L2 changes and, therefore, the back focus of the tube lens system changes. In order for a real image to be formed always at the same location of the microscope viewer 2 and for the back focus to be adapted to this fixed position within the microscope viewer 2, the lens L2 is also displaceable, and the displacement of the lens 2 is coupled with the displacement movement of the microscope objective 1 by a predetermined gear ratio. The displacement of lens 2 is coupled indirectly, so to speak, with the displacement movement of the microscope objective 1 and of the magnification changers.

A concrete example for the construction of the lenses L1, L2 and L3 and of their distances relative to one another is indicated in the following.

For example, members of a mechanical gear unit or also electric-motor assemblies communicating with a control circuit serve to transmit the displacement movement to the lenses which are positively coupled with the microscope objective. A gear ratio oriented to the desired displacement path and the displacement speed is predetermined.

As an alternative to the first advantageous construction, the microscope can be outfitted with a tube lens system having a cemented component of invariable back focus comprising a plurality of lenses, and the distances between the microscope viewer, the object and the cemented component are constant when changing distance z. An example for this is also indicated further below.

The invention will be described more fully in the following with reference to two embodiment examples.

### BRIEF DESCRIPTION OF THE DRAWINGS

In the accompanying drawings:

FIG. 1 shows the basic construction of a telescope-type stereo microscope according to the prior art in a side view;

FIG. 2 shows the basic construction of the microscope according to the invention which is outfitted with a tube lens system with variable back focus;

FIG. 3 shows the basic construction of the microscope according to the invention outfitted with a tube lens system with invariable back focus;

FIG. 4 shows the lenses of a tube lens system with variable back focus for use in the microscope construction according to FIG. 2; and

FIG. 5 shows the lenses of a tube lens system with invariable back focus for use in the microscope construction according to FIG. 3.

### DESCRIPTION OF THE PREFERRED EMBODIMENTS

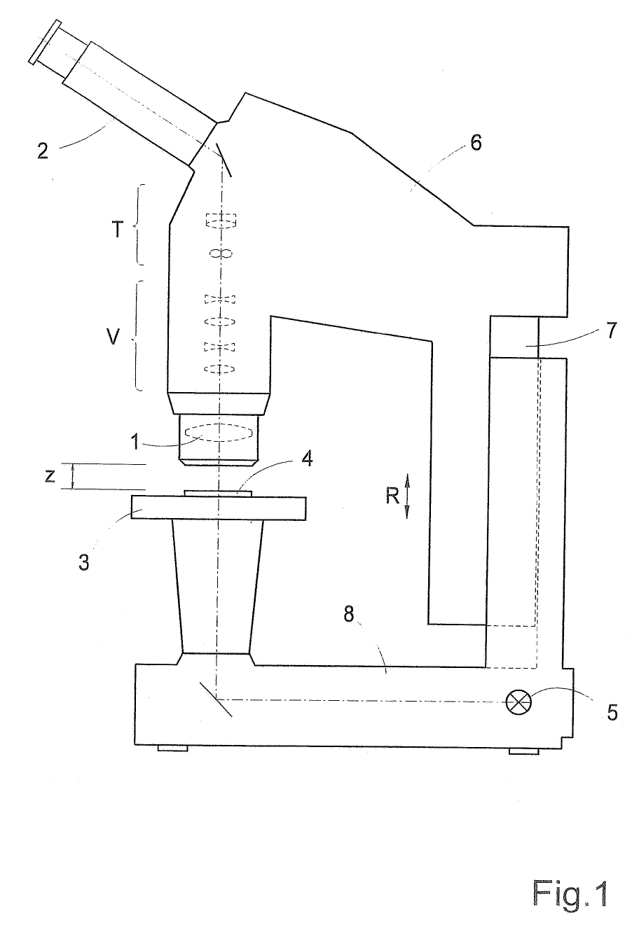

FIG. 1 shows a highly simplified view of the construction of a telescope-type stereo microscope. The microscope is shown in a side view. The two imaging beam paths exiting from tie microscope objective 1 lie one behind the other in the viewing direction on the drawing plane so that only one imaging beam path is visible and the second imaging beam path lying below the drawing plane is concealed.

The microscope has, in both imaging beam paths, a tube lens system in area T and a magnification changer in area V and is further outfitted with a microscope viewer 2. An optical infinity space is formed between the tube lens system and the magnification changer and is identified in FIG. 1 by the symbol ∞.

An object 4 to be observed through the microscope viewer 2 is placed on an object stage 3. The desired imaging scale can be adjusted with the magnification changers. An illumination device 5 can be arranged below the object stage 3.

To use a microscope of this type for observing different planes of the object 4 that are offset in depth, it is necessary to orient the focus of the microscope objective 1 to the respective plane. This is accomplished by changing the distance z between the microscope objective 1 and the object 4. For increasing the distance z, the entire microscope superstructure, which comprises the microscope objective 1, the microscope viewer 2, the tube lens system, the magnification changers, and the other assemblies of the microscope body 6 which are not designated individually is displaced relative to the microscope stand 8 in direction R, indicated by the double-arrow, along a straight-line guide 7 by means of an appropriately constructed drive.

When the distance z is increased, the displacement is carried out opposite to the direction of the force of gravity. For this purpose, the straight-line guide and the drive, which are not shown here, must be constructed in terms of their stability taking into account the significant mass that must be moved by the displacement.

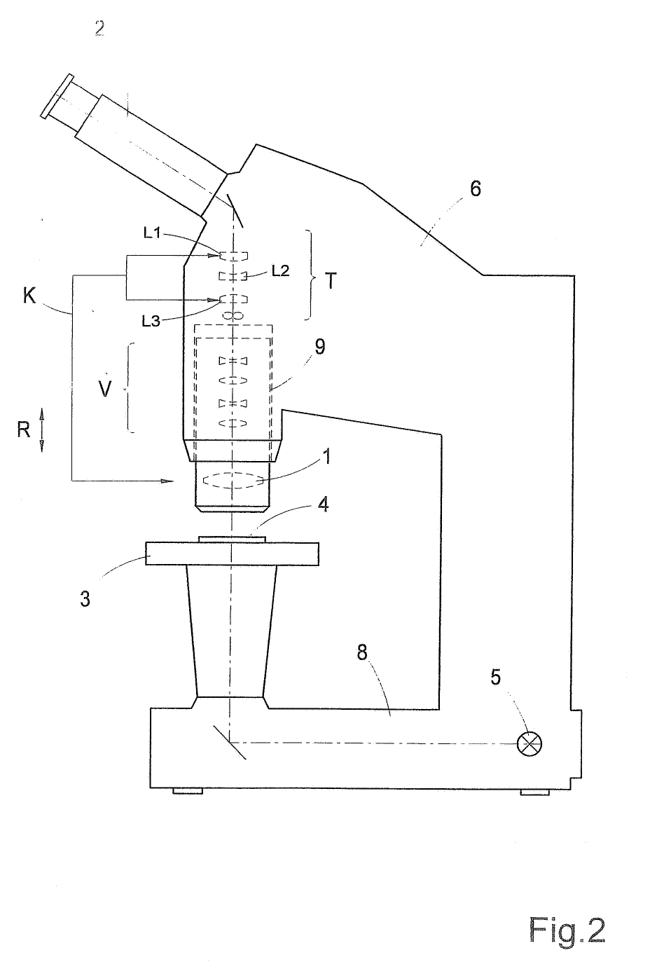

In order to reduce the mass to be moved, a microscope superstructure according to the invention which is shown in a first constructional variant in FIG. 2 is provided. For the sake of clarity, the reference numbers used to designate individual assemblies in FIG. 1 are retained in FIG. 2.

In the microscope construction shown in FIG. 2, in contrast to the prior art shown in FIG. 1, only the microscope objective 1 and, along with it, the magnification changers rather than the entire microscope superstructure are displaceable in direction R indicated by the double-arrow, while the rest of the microscope superstructure, including the microscope viewer 2, remains in position.

In order to accomplish this, a tube lens system comprising three lenses L1, L2, L3 is provided and the back focus of this tube lens system is variable while the focal length remains constant.

When the distance z is changed, the lenses L1 and L3 are displaced by the same distance that the microscope objective 1 is displaced in direction R together with the magnification changers; in other words, the displacement of the lenses L1 and L3 is directly coupled with the displacement of the microscope objective 1 and of the magnification changers. In so doing, the position of lenses L1 and L3 relative to lens L2 changes and therefore the back focus of the tube lens system changes.

In order, nevertheless, for a real image to be formed always at the same location of the microscope viewer 2 and the back focus to be adapted to this fixed position within the microscope viewer 2, the lens L2 is also displaceable. The displacement of the lens 2 is indirectly coupled with the displacement movement of the microscope objective 1 and of the magnification changers by a predetermined gear ratio.

In the constructional variant selected in this instance, the displacement of the microscope objective 1 is carried out in a straight line along a straight-line guide 9. The direct coupling of the displacement movement of the microscope objective 1 with the displacement of the lenses L1 and L3 is shown symbolically in FIG. 2 by a connecting line K. The coupling of the displacement movement of the microscope objective 1 with the displacement of the lens L2 by a gear ratio is not shown in the drawing.

In order to adjust the focus to different observation planes in the object 4, it is still necessary to change the distance z. However, the mass to be moved is substantially reduced and the technical means for realizing this displacement movement can be manufactured more easily and with less technical effort and, therefore, also more economically.

The lenses L1 to L3 can be constructed, for example, as is indicated in the following table, with radius r, thickness d and distances a in mm, refractive index nₑ at wavelength 546.07 nm, Abbe number vₑ, and focal lengths f:

| | | | | Refractive | Abbe | Focal length |
|---|---|---|---|---|---|---|
| | Radius r | Thickness d | Distance a | index nₑ | number νₑ | f′ |
| L1 | 273.65 | 4.0 | | 1.622470 | 63.19 | 122.00 |
| | −104.52 | | | | | |
| | | | a1 = 11.0 ± 9 | | | |
| L2 | 272.80 | 2.5 | | 1.584820 | 40.56 | −87.48 |
| | 63.18 | | | | | |
| | | | a2 = 10.0 ± 9 | | | |
| L3 | 81.92 | 4.0 | | 1.622470 | 63.16 | 131.00 |
| | infinity | | | | | |
| | | | a3 = 181.66 ± 23.4 | | | |

The lens L1 is arranged on the object side. The back focus of this tube lens system is variable, while the focal length F in the selected example is a constant 200 mm. The principle of the invention can be transferred to tube lens systems of variable back focus with focal lengths F in the range of 100≦F≦250.

The displacement mechanisms and the associated drives are not shown. However, their construction can readily be assumed from the field of precision mechanics. For example, members of a mechanical gear unit or electric-motor assemblies communicating with a control circuit can be provided for transmitting the displacement movement of the microscope objective 1 to the lens L2.

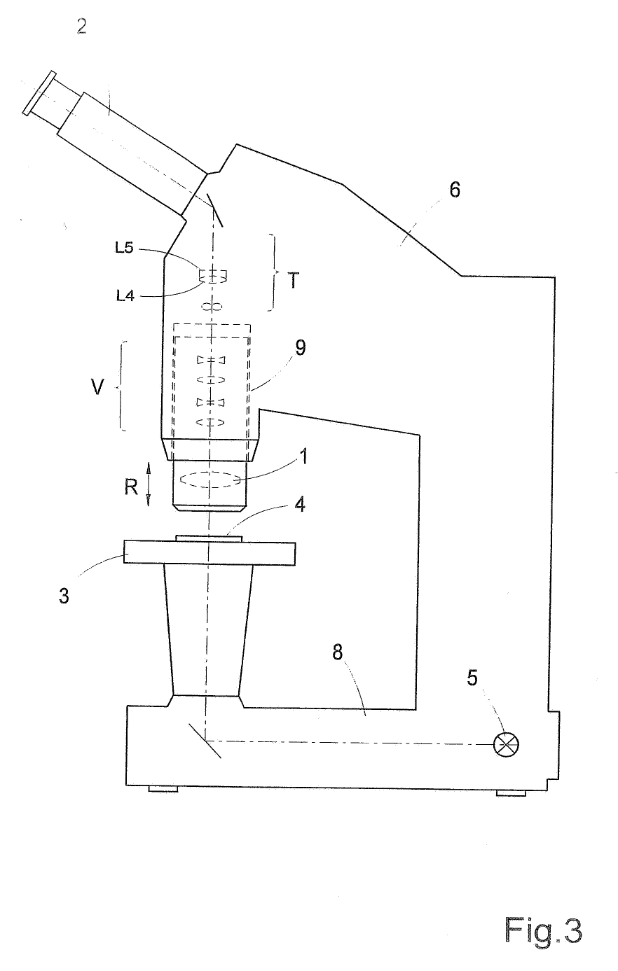

In a second constructional variant shown in FIG. 3, the object upon which the invention is based is met by a tube lens system whose back focus is invariable. For the sake of clarity, the reference numbers assigned to the individual assemblies from FIG. 1 and FIG. 2 is retained in FIG. 3.

In this case, the tube lens system has a cemented component comprising two lenses L4 and L5. When distance z is changed, the distances between the microscope viewer 2, the object 4 and the cemented component are constant; that is, in contrast to the constructional variants described with reference to FIG. 2, neither of the two lenses L4 and L5 of the cemented component is coupled with the displacement movement of the microscope objective 1.

A cemented component comprises, e.g., the two lenses L4 and L5 which are constructed with the radius r, thickness d, refractive index nₑ at wavelength 546.07 mm, and Abbe number Vₑ indicated in the following table, where lens L4 is arranged on the object side:

| | | | Refractive | Abbe |
|---|---|---|---|---|
| | Radius r | Thickness d | index nₑ | number νₑ |
| L4 | 101.45 | 5.5. | 1.622470 | 63.19 |
| | −46.308 | | | |
| L5 | −46.308 | 2.4 | 1.584820 | 40.56 |
| | infinity | | | |

The particular advantage of this second constructional variant according to FIG. 3 over the first constructional variant according to FIG. 2 results from the omission of the mechanical devices for transmitting the displacement movement of the microscope objective 1 to one or more lenses of the tube, but covers a smaller area with respect to distance z.

With both constructional variants, in contrast to the prior art shown in FIG. 1, for the adjustment of the focus on different observation planes, only the microscope objective 1 and the magnification changer, and not the entire microscope superstructure, are displaceable in direction R, while the rest of the microscope superstructure, including the microscope viewer 2, remains in position.

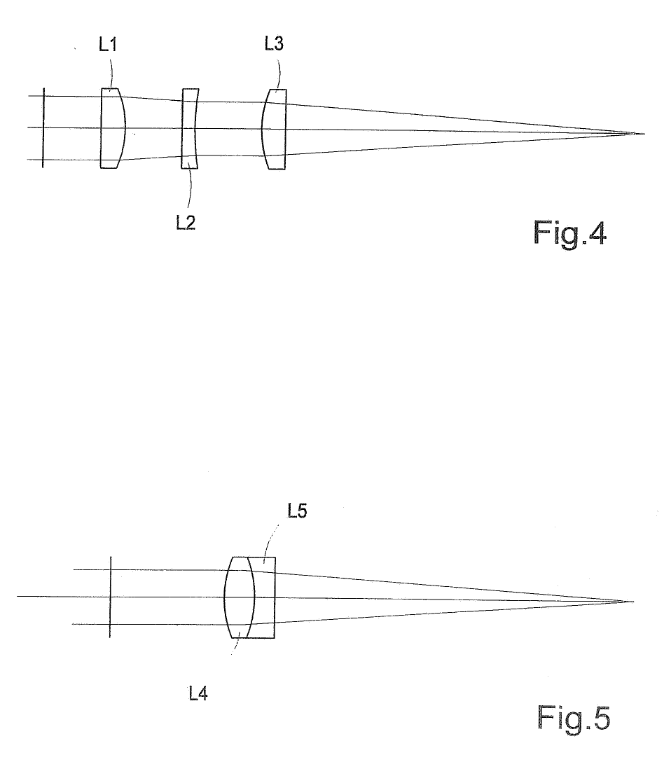

FIG. 4 shows the lenses L1, L2, and L3 of the tube lens system with variable back focus, and FIG. 5 shows lenses L4 and L5 of the tube lens system with invariable back focus in enlarged views.

While the foregoing description and drawings represent the present invention, it will be obvious to those skilled in the art that various changes may be made therein without departing from the true spirit and scope of the present invention.

### Reference Numbers

1 microscope objective
2 microscope viewer
3 object stage
4 object
5 illumination device
6 microscope body
7 straight-line guide
8 microscope stand
9 straight-line guide
L2, L3, L4, L5 lenses
K connecting line
R direction
z distance between the microscope objective and the object

What is claimed is:

1. A telescope-type stereo microscope comprising:
a microscope objective;
a tube lens system in each of the two stereoscopic imaging beam paths downstream of the microscope objective;
a magnification changer in each of the two stereoscopic imaging beam paths between the microscope objective and the tube lens system;
means for adjusting the focus position by changing the distance z between the microscope objective and an object to be observed; and
wherein distances between the object and the microscope viewer and the distance of at least one lens of the tube lens system from the microscope objective or from the microscope viewer being constant when changing the distance z, and a real image always being formed at the same location of the microscope viewer.

2. The stereo microscope according to claim 1, wherein the back focus of the tube lens system is variable, while the focal length F in the selected example is constant at 200 mm.

3. The stereo microscope according to claim 1, with a tube lens system comprising three lenses L1, L2, L3, wherein the distances between the microscope objective, the magnification changer coupled with the latter, and two lenses L1 and L3 are constant, while the third lens L2 is positively coupled with the displacement of the microscope objective when changing distance z, so that the back focus of the tube lens system changes when changing distance z and a real intermediate image is accordingly always formed at the same location in the microscope viewer.

4. The stereo microscope according to claim 3, wherein the lenses L1 to L3 are constructed with radius r, thickness d and distances a in mm, refractive index nₑ at wavelength 546.07 nm, Abbe number vₑ, and focal lengths f as indicated in the following table, and the lens L3 is arranged on the object side:

| | | | | Refractive | Abbe | Focal length |
|---|---|---|---|---|---|---|
| | Radius r | Thickness d | Distance a | index nₑ | number νₑ | f′ |
| L1 | 273.65 | 4.0 | | 1.622470 | 63.19 | 122.00 |
| | −104.52 | | | | | |
| | | | a1 = 11.0 ± 9 | | | |
| L2 | 272.80 | 2.5 | | 1.584820 | 40.56 | −87.48 |
| | 63.18 | | | | | |
| | | | a2 = 10.0 ± 9 | | | |
| L3 | 81.92 | 4.0 | | 1.622470 | 63.16 | 131.00 |
| | infinity | | | | | |
| | | | a3 = 181.66 ± 23.4 | | | |

5. The stereo microscope according to claim 1, wherein the tube lens system has a cemented component comprising a plurality of lenses, and the distances between the microscope viewer, the object and the cemented component are constant when changing distance z.

6. The stereo microscope according to claim 2, wherein the tube lens system has a cemented component comprising a plurality of lenses, and the distances between the microscope viewer, the object and the cemented component are constant when changing distance z.

7. The stereo microscope according to claim 5, wherein the cemented component comprises two lenses L4 and L5 which are constructed with the radius r, thickness d, refractive index nₑ at wavelength 546.07 nm, and Abbe number vₑ indicated in the following table, where lens L4 is arranged on the object side.
